(19) United States
(12) Patent Application Publication
(10) Pub. No.: US 2015/0310560 A1
(43) Pub. Date: Oct. 29, 2015

(54) Systems And Methods For Improving Government Financing Of Infrastructure Services/Improvements

(71) Applicant: Terra Firma Portfolio Inc., New York, NY (US)

(72) Inventors: M. Gary LaFever, Lyons, CO (US); Ted N. Myerson, New York, NY (US); Samantha L. Hampton, Greeley, CO (US)

(21) Appl. No.: 14/695,952

(22) Filed: Apr. 24, 2015

Related U.S. Application Data
(60) Provisional application No. 61/984,453, filed on Apr. 25, 2014.

(51) Int. Cl. G06Q 40/00

(52) U.S. Cl. CPC G06Q 40/10

(57) ABSTRACT

Disclosed herein are various categorization and rating systems for tax liens, tax deeds, and/or non-ad valorem (NAV) liens, as well as associated methods that facilitate classifications and ratings across various local governmental jurisdictions according to a common, referenceable categorization and/or rating scheme. The common categorization and/or rating scheme facilitates identification of tax liens, tax deeds and/or NAV liens having common underlying real property characteristics, investment characteristics, or other characteristics. In one example, a computer categorizes the tax liens, tax deeds and/or NAV liens into subgroups, and determines a rating based on one or more characteristics, including the likely desirableness as an investment vehicle to certain classes of investors. The categorized tax lien/tax deed and/or NAV lien information and the ratings may be made available to third-party computing devices (such as mobile devices or tablets) used by potential investors to evaluate the possible purchase thereof.

### CROSS-REFERENCE TO RELATED APPLICATIONS

This application claims priority to U.S. Provisional Patent Application Ser. No. 61/984,453, entitled, “Systems and Methods for Improving State, County and Municipal Government Financing Programs,” filed Apr. 25, 2014 (“the '453 application”). The '453 application is hereby incorporated by reference in its entirety. This application is also related in subject matter to U.S. Pat. No. 8,738,479, which issued May 27, 2014 (“the '479 patent”). The '479 patent is also hereby incorporated by reference in its entirety.

### FILED OF THE INVENTION

This disclosure relates generally to improving methods and systems for government financing of infrastructure services/improvements using property-related taxes.

### BACKGROUND

A.1: United States—Introduction

In the United States of America (“the U.S.”), state, county, and municipal governments collect taxes to finance infrastructure services/improvements for their citizens. Some examples of infrastructure services/improvements include economic infrastructure (e.g., transport systems and utility networks), social infrastructure (e.g., education and health services), and environmental infrastructure (e.g., water and sewerage networks). Most county or municipal governments (also referred to herein as, “Local Governments”) earn a majority of their revenue (outside of revenue received from the applicable state in which they are located) from taxes assessed on property located within their respective jurisdictions. When a property owner fails to pay property taxes due on their property to finance local government infrastructure operations, there is a concomitant loss of income to the local government. In an effort to attempt to ameliorate this problem and to minimize this loss of income to local governments, different approaches have evolved in the U.S. for enforcement/collection of: (i) ad valorem taxes (i.e., taxes based on the assessed value of real estate—ad valorem is Latin for “according to value”), such as tax deeds and tax lien certificates; and (ii) non-ad valorem taxes (i.e., taxes that are not based on the value of the underlying property).

A.2: U.S.—Tax Deed Jurisdictions

Twenty-two states in the U.S. are “Tax Deed” states, under which a local government has the authority to sell underlying property at auction to a purchaser if a property owner fails to pay ad valorem taxes due to the local government within a certain period of time. Generally, the local government receives the amount of unpaid taxes, penalties, and costs from the proceeds of the sale—with any excess monies received over the unpaid taxes, penalties, and costs payable to the owner of the property on which the taxes, penalties and costs were levied.

A.3: U.S.—Tax Lien Certificate Jurisdictions

Twenty-eight states in the U.S. are “Tax Lien Certificate” or “Tax Lien” states, under which a local government has the authority to sell to an investor a certificate or other instrument representing a lien on the property based on the amount of ad valorem taxes owed by the owner to the local government, plus any penalties or costs, if a property owner fails to pay their ad valorem taxes within a certain period of time. The delinquent property owner is given a period of time, generally called a “redemption period,” to pay the tax lien certificate plus interest and costs. If the delinquent owner does not pay the tax lien certificate off within the redemption period, the tax lien certificate holder can acquire title to the property that is superior in right to mortgages and most other liens against the property.

A.4: U.S. Non-Ad Valorem (NAV) Liens

Local governments may underwrite expenses associated with economic, social, environmental and/or other infrastructure services/improvements by assessing taxes based on some measure or allocation other than the value of real property, such as the improvement or service cost allocated to a property made on a benefit unit basis (for purposes hereof, these taxes will be referred to as, “Non-Ad Valorem Taxes” or “NAV Taxes”). For example, Florida law defines non-ad valorem taxes as “those assessments which are not based upon millage and which can become a lien against a homestead as permitted.” Collection of unpaid NAV Taxes may be enforced by levying liens for unpaid NAV Taxes on associated real property (“NAV liens”).

A.5: United States—Generally

The primary means of selling tax liens, tax deeds and NAV liens is via auctions. These auctions are largely manual processes that are expensive for local governments to arrange, manage, and conduct. A small number of local governments are working with companies like Realauction.com to automate certain aspects of the current auction process. However, auctions—whether they occur in the real world or in the “virtual” world online—require significant time and expertise on the part of tax lien, tax deed and/or NAV lien investors to assess the relative merits of the different tax liens, tax deeds and/or NAV liens available for sale.

The specifics of local laws, the nature of each underlying property, attributes of the property and/or owner of the property (including the owner's financial and credit risk profiles), the likelihood that the investment will produce a positive return on investment (i.e., the type of investment opportunity that each tax lien, tax deed and/or NAV lien represents) are each factors that investors may spend considerable time and resources researching prior to participating in an auction. Significant returns can still be generated, however, by investing at tax lien, tax deed and/or NAV lien auctions (i.e., the current “Primary Market”), as well as by purchasing and selling tax liens, tax deeds and/or NAV liens between parties after being purchased directly from local governments (i.e., the current “Secondary Market”).

To date, attempts to “securitize” tax lien, tax deed and/or NAV lien investing to improve economies of scale have been limited to: (a) negotiated bulk sale of tax liens, tax deeds and/or NAV liens; and (b) securitization of tax liens, tax deeds and/or NAV liens by means of grouping tax liens, tax deeds and/or NAV liens together under ownership of a special purpose legal vehicle (“SPV”), under which interests in the SPV are then sold to investors. In the case of both bulk sales and sales of interest in tax lien, tax deed and/or NAV lien SPVs, the underlying tax liens, tax deeds and/or NAV liens originate from the same local government—i.e., the tax liens, tax deeds and/or NAV liens are grouped by the originating local government source itself.

Further, any analysis of the type of investment opportunity represented by the bulk sale/SPV (e.g., specifics of local laws, nature of each underlying property, attributes of the property and/or owner of the property, including financial and credit risk profiles) are limited to only those specific tax liens, tax deeds and/or NAV liens contained within a particular bulk sale or SPV.

As stated in the National Consumer Law Center report entitled, “The Other Foreclosure Crisis”: “All states have laws that permit local governments to sell property through a tax lien foreclosure process if the owner falls behind on property taxes or other municipal charges. . . . These laws serve an important purpose in ensuring that local governments recover tax revenue needed to provide essential government services. However, states rarely update these laws to reflect current economic conditions or to ensure that proper safeguards exist to avoid unnecessary loss of homeownership. . . . The tax sale procedures in most states are exceedingly complicated and are generally understood only by investors and purchasers. Inadequate notice and a lack of judicial oversight over the process leave many homeowners in the dark about steps they can take to avoid a home loss. Homeowners most at risk are those who have fallen into default because they are incapable of handling their financial affairs, such as individuals suffering from Alzheimer's, dementia, or other cognitive disorders.”

In addition to the hardships experienced by local governments and property owners under existing tax lien, tax deed and/or NAV lien financing models, the highly fragmented and regionalized nature of tax lien, tax deed and/or NAV lien investing is also challenging to investors. For example, there are over 9,000 local governments in the U.S. that engage in tax lien, tax deed and/or NAV lien sales on an annual basis, and institutional investors typically attend only those auctions where they can buy at least one million dollars (US$1,000,000) in liens, since these investors try to keep their “acquisition cost” below five percent. In addition, there has been significant negative press regarding hardships suffered by homeowners who lost their homes and suffered ancillary losses due to the practices of certain tax lien, tax deed and/or NAV lien investors. Due to this negative publicity, as well as to other factors—chief among them being the risk and return issues articulated above—certain investors have chosen to no longer participate in tax lien, tax deed and/or NAV lien investing.

B: Developed Countries—Non-U.S.

Information contained in this section is derived from United Nations Human Settlements Programme publications entitled Property Tax Regimes in Europe (ISBN Volume Number: 978-92-1-132565-2) and Guide to Finance Infrastructure and Basic Services (ISBN Volume Number: 978-92-1-132561-4).

Public finance experts regard taxes on “real property” (which term for purposes of this application includes rights pertaining to “immovable property” comprised of interests and benefits connected with real estate, i.e., the physical piece of property, together with any structures and/or improvements on that property, as well as the property itself) as a suitable source of revenue for local governments. They also believe that financing of infrastructure improvements using property related taxes contributes to a well-balanced revenue system. Revenue systems that include a mix of taxes and other sources of revenue make it easier to find a balance among competing policy objectives, weather economic difficulties, and compete effectively in the global economy.

The basic system of government can influence the structure and role of property taxes. In a federal system of government, where powers—including taxation powers—are constitutionally assigned, local governments tend to have more autonomy and discretion than under a unitary government. Under a unitary government, any sub-national governments usually derive their powers from the central government, not the constitution. However, the basic system of government is not an infallible indicator of the nature of a property tax system, reliance on property taxes, or local autonomy. Potential implementations of the methods and systems described in this application may apply to any local government, whether under a federal system of government or under a unitary government.

Most tax powers in developed countries are retained by central governments, with the regional governments sometimes sharing the revenues arising from income and/or sales taxes with central government. Local government taxes are normally restricted to property taxes. There are various forms of property tax, including those based on the rental or capital values of property and those based on property characteristics, such as numbers of rooms or floor area. Property characteristics are used as the tax base where rental and capital values are not available because of lack of functioning property markets. Property taxes are typically levied separately on business properties and residential properties, so as to allow for different rates and bases of tax. The rate of property taxes generally covers all properties in the local government jurisdiction, but supplementary rates of property tax may be levied in particular parts of a local government area in order to finance additional infrastructure specific to a (typically business) district, for example Business Improvement Districts (BIDs) and supplementary business property taxes.

C: Developing Countries

Information contained in this section is derived from United Nations Human Settlements Programme publications entitled Property Tax Regimes in Europe (ISBN Volume Number: 978-92-1-132565-2) and Guide to Finance Infrastructure and Basic Services (ISBN Volume Number: 978-92-1-132561-4).

Global infrastructural investment needs are enormous, amounting to tens of trillions of U.S. Dollars (USD). The international economic Organization for Economic Co-operation and Development (OECD) estimates that some USD 4 trillion are required for investment in electricity supply, USD 5 trillion for roads, USD 8 trillion for telecoms and USD 18 trillion for water supply and sewerage systems—primarily in developing countries, due to their fast growing populations and increasing urbanization.

It is often argued that investment in infrastructure will ‘pay for itself’ in the long run because there is a strong positive correlation between growth of productivity and investment in infrastructure, the direction of causation generally being assumed to be from the latter to the former. Improvements in productivity arise not only from economic infrastructure (e.g., transport systems and utility networks) but also social infrastructure (e.g., education and health services) and environmental infrastructure (e.g., water and sewerage networks). Improved transport systems and better-educated, better-trained and healthier working populations are all prerequisites of economic growth.

These three categories of infrastructure are complementary and, in combination, can be expected to magnify improvements in productivity—leading to increased competitiveness and so (it is hoped) to increased exports and/or reduced imports. This creates jobs and economic prosperity which, in turn, can be expected to lead to higher revenues from national, local and regional taxes as incomes and wealth increase, as do the increased expenditures they finance. Those revenues can be used, not only to provide the urgently required basic public services, but also to repay the debt associated with government borrowing money from the financial markets to fund investment in their infrastructures.

Hence, rather than rely on hoped-for future economic prosperity to repay the debt incurred in funding infrastructure, developing countries must consider not only from where to get funds for infrastructure but also how to finance repayment of the associated debt. Funding and financing infrastructure must be considered simultaneously if infrastructure is to be provided and maintained and upgraded on a sustainable and resilient basis over its lifetime.

According to the United Nations Human Settlements Programme, there is huge potential for funding infrastructure via pension and insurance funds. Some USD 19.1 trillion of funds were managed by pension funds at the end of 2010, of which 96% was accounted for by OECD countries. In December 2010, OECD pension fund assets amounted to 71.6% of GDP on average. Australia, Canada, the Netherlands, UK and USA have very large investment funds of between 60% and 135% of their GDP. It can be expected that an increasing proportion of funding for infrastructure will come from pension funds for a number of reasons. First, as a result of the 2007-2009 credit crunch, pension and insurance funds are probably more wary of being overly dependent upon increasingly risky sovereign debt and highly volatile world stock markets, earnings from which may also be heavily dependent upon volatile exchange rates. In seeking portfolio diversification, such funds are increasingly looking for more stable long-term investments, including regulated utilities. Second, the attraction for insurance and pension funds is that the regulated utility sectors tend to be insulated from the business cycle (unlike stock markets), and so have relatively stable predictable cash flows. Third, this type of infrastructure is also compatible with the 50 years or so time horizon of pension and insurance funds, whereas equity investments are short term—as well as inherently unstable. Investment in utilities is certainly more stable than investing in ‘hit and run’ private equity groups that buy up underperforming companies then sack managers, sell underused or redundant assets and restructure those companies prior to selling them at a profit that reflects their increased earnings potential.

The suitability of infrastructural investments for pension funds begs the question as to why they have not invested in them much more than has been the case in the past. One possible explanation presented by the United Nations Human Settlements Programme is that pension funds tend to work through agents who are not knowledgeable about infrastructure investments. The United Nations Human Settlements Programme notes that both developed and developing countries must overcome this barrier if they are to promote investment in infrastructure by pension and insurance funds. Implementations of the methods and systems described in this application may help overcome complexities and limitations associated with infrastructure investments.

D: What is Needed in the U.S. and Globally

What is needed in the U.S. and globally is a way to more efficiently and effectively streamline governmental property tax systems, such that they become a viable and profitable avenue for investors, which will also, in turn, help governmental entities recoup more in lost tax revenues, which may be used, e.g., to finance infrastructure services/improvements.

For purposes of this application, the following terms used in the context of: (i) the U.S.; (ii) developed countries outside of the U.S.; and/or (iii) developing countries, shall have the meanings ascribed to them below: “Local Government” means central, regional, and/or other local governmental jurisdictions engaged in assessment and/or enforcement of ad valorem and/or non-ad valorem taxes on real property; “Ad Valorem Taxes” means taxes based on the assessed value of real estate; “Non-Ad Valorem Taxes” means taxes not based on the assessed value of real estate; “Tax Deed” means an instrument by which a local government has the authority to sell underlying property at auction to a purchaser if a property owner or property user fails to pay ad valorem taxes due to the local government within a certain period of time; “Tax Lien” or “Tax Lien Certificate” means a certificate or other instrument representing a lien on real property based on the amount of ad valorem taxes owed by the property owner or property user to the local government, plus any penalties or costs, if the property owner or property user fails to pay ad valorem taxes within a certain period of time; “NAV” lien means the instrument by which a local government has the authority to sell underlying property at auction to a purchaser if a property owner or property user fails to pay non-ad valorem taxes due to the local government within a certain period of time.

### BRIEF DESCRIPTION OF DRAWINGS

FIG. 1 illustrates a system for facilitating the automation of categorization and rating of tax deeds, according to one embodiment.

FIG. 2 illustrates a system for facilitating the automation of categorization and rating of ‘non-ad valorem’ (NAV) taxes and/or assessments that may give rise to legal encumbrances on real property, according to one embodiment.

FIG. 3 illustrates, in flow chart form, a method for facilitating the classification of tax liens/tax deeds and/or NAV liens into different categories based on one or more characteristics and/or one or more ratings, according to one embodiment.

FIG. 4 illustrates, in flow chart form, a method for facilitating the sale of properties subject to purchased but unredeemed tax liens, tax deeds, and/or NAV liens, according to one embodiment.

FIG. 5 illustrates, in flow chart form, a method for facilitating the establishment of ‘safety-net’ financing programs to provide assistance to property owners and to assist them in paying tax lien/tax deed/NAV lien obligations before loss of subject properties, according to one embodiment.

FIG. 6 illustrates, in flow chart form, a method for facilitating the calculation of risk/likelihood, etc. of tax lien/tax deed/NAV liens arising due to non-payment, as determined by one or more types of financial analysis, according to one embodiment.

FIG. 7 illustrates, in flow chart form, a method for facilitating the creation of new asset class(es) backed by tax liens/tax deeds and/or NAV liens, according to one embodiment.

FIG. 8 illustrates, in flow chart form, a method for facilitating the creation of derivative securities comprised of contracts between or among two or more parties, according to one embodiment.

FIG. 9 illustrates, in flow chart form, a method for facilitating the creation of data feeds comprised of information pertaining to tax liens/tax deeds and/or NAV lien information that can be used to track, forecast, predict, model, and report on assessment and/or repayment of tax liens/tax deeds and/or NAV liens, according to one embodiment.

FIG. 10 illustrates, in flow chart form, a method for facilitating the leveraging of third party sources to obtain more information on properties and/or owners to further refine expected categorization/ranking of liens and/or deeds, according to one embodiment.

FIG. 11 illustrates, in flow chart form, a method for facilitating the creation of generalized tax lien/tax deed and/or NAV lien ratings based on generalized investment objectives, creation of investor profile, and/or investment goals, according to one embodiment.

FIG. 12 illustrates, in flow chart form, a method for facilitating the packaging of: (i) tax liens/tax deeds and/or NAV liens; (ii) securities representing new asset class(es) backed by tax liens/tax deeds and/or NAV liens; and/or (iii) derivative securities dependent upon (or derived from) one or more underlying new asset class(es) backed by tax liens/tax deeds and/or NAV liens into ‘annuity-type’ products, according to one embodiment.

FIG. 13 illustrates, in flow chart form, a method for facilitating the tracking of information pertaining to how and when tax liens/tax deeds and/or NAV liens are assessed, redeemed, etc., for the purpose of deriving statistics related to how tax liens/tax deeds and/or NAV liens are resolved, according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been selected principally for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

The embodiments described herein are examples and for illustrative purposes. Persons of ordinary skill in the art will recognize that alternative techniques for implementing the disclosed subject matter may be used. Elements of example embodiments may be arranged in different arrangements or combined with elements of different example embodiments. For example, the order of execution of blocks and flow charts may be changed. Some of the blocks of those flowcharts may be changed, eliminated, or combined and other blocks may be added as desired.

As used herein, the term “a computer system” can refer to a single computer or a plurality of computers working together to perform the function described as being performed on or by a computer system.

Disclosed herein are various systems and methods for improving local government financing for infrastructure services/improvements.

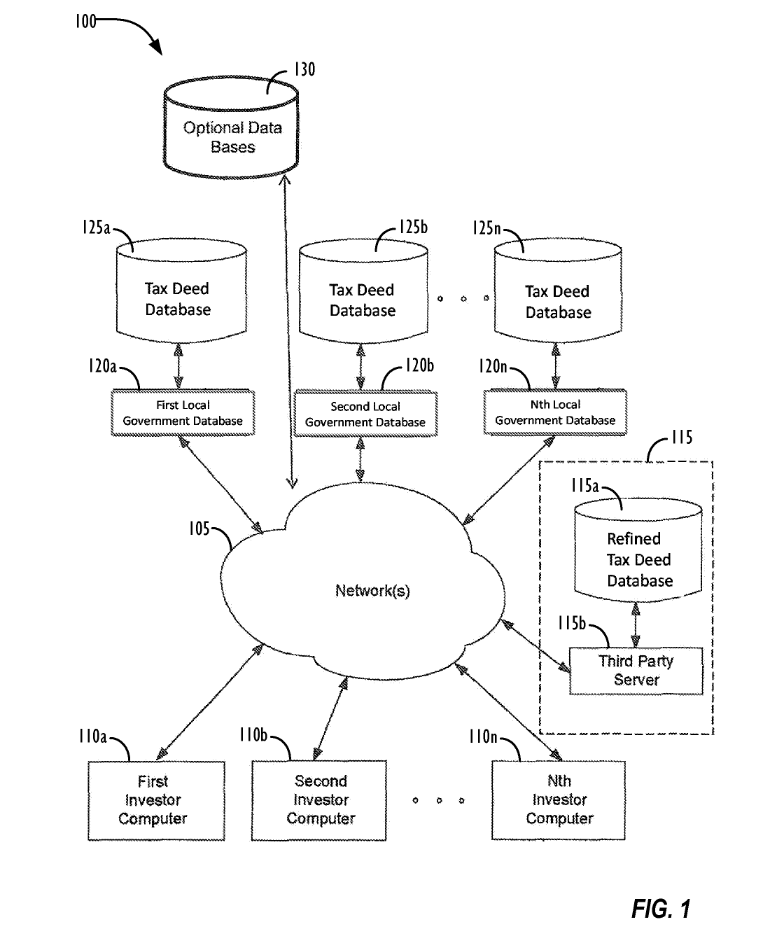

FIG. 1 depicts a system 100 for facilitating the automation of the categorization and rating of tax deeds. The improvements to tax deed systems and methods described herein can maximize associated revenues and save the local government financial resources associated with making tax deeds available for purchase by investors. (It should be noted that these improvements are also applicable to tax lien systems and hybrid tax lien/tax deed systems.)

According to one embodiment, tax deeds may be organized into categories and/or subsets that can facilitate comparison among other tax deeds and/or the identification of tax deeds that meet certain investment parameters. Further details regarding examples of categorization and ratings schemes for tax liens/tax deeds may be found in the '479 patent, which is incorporated by reference.

System 100 comprises one or more investor computers (110a-110n) that connect through a network 105 (e.g., the Internet, or any other LAN or WAN that facilitates communication between computers) to one or more local government computing systems (120a-120n). Local government computing systems may comprise systems communicatively coupled with the appropriate underlying tax lien/tax deed database 125a-125n. The databases 125 may comprise, for example: county tax databases, state tax databases, municipal tax databases, and/or databases containing tax lien/tax deed information for the appropriate tax-assessing authority for a given jurisdiction within the country where the taxed property is located (e.g., province, city-state, principality, village, etc.). As will be explained further herein, investors 110 may also be in contact with a number of other databases as part of system 100, for example: optional data bases 130 and refined tax lien/tax deed database system 115 (comprising refined tax lien/tax deed database 115a and a third party server 115b).

According to one broad aspect of an embodiment of the present invention, disclosed herein are a computer system and methods for rating a plurality of tax deeds for real properties from one or more local government computing systems across the country, wherein each such system has at least one local government database containing local government tax deed information relating to each of the tax deeds of each real property in a local government jurisdiction. In one example, the computer system of this embodiment of the invention comprises at least one computer 110 connected to a network 105 and adapted to communicate with the one or more local government computing systems 120 to receive the local government tax deed information including each of said one or more tax deeds, the at least one computer 110 determining one or more ratings of each of said one or more tax deeds; and at least one database 115 connected with the at least one computer, the at least one database configured to store each of said one or more ratings associated with each of said one or more tax deeds; wherein the one or more ratings of each of the at least one tax deeds is accessible from the at least one database over the network to one or more third party computers, wherein, in one embodiment, such computers may be used by potential investors with respect to evaluating, investing in, or otherwise examining or making decisions based on attributes of and associations with the one or more tax deeds. In this manner, this embodiment provides ratings of each tax deed across the one or more local government tax-levying jurisdictions, and these ratings can be used by potential investors to analyze potential purchases of tax deeds from different local governments.

In one example, the one or more ratings of each of said tax deeds are based on one or more common characteristics of the tax deeds, and/or the one or more ratings of each of said tax deeds are based on one or more shared, similar, or otherwise related or comparative characteristics of the real properties associated with the tax deeds. For instance, the one or more ratings of each of said tax deeds may include an indication of whether a tax deed relates to a residential property, a commercial property, and/or a vacant property. In another example, the one or more ratings of each of said tax deeds may be based upon an assessed value of a property, an amount of a tax deed, an assessed land value of the real property associated with a tax deed, and/or an assessed building value of the real property associated with a tax deed. In this manner, by the computer determining a rating for each tax deed based on common characteristics of each tax deed, the computer system can provide the ratings to potential investors so that the investors can use the ratings to quickly compare various tax deeds in one or more local government tax-levying jurisdictions, thereby helping the investor evaluate, invest in, or otherwise examine or make decisions concerning which tax deeds the investor may wish to purchase, recommend or otherwise take an action with respect to such tax deeds.

In another example, the at least one computer of the system obtains other information relating to each tax deed, e.g., from optional databases 130, which information may include mortgage information related to the real property associated with the tax deed; bankruptcy information related to an owner of the real property associated with the tax deed; and/or other items of information as disclosed herein. This additional information may be used to further refine the computer rating for the tax deeds.

According to another broad aspect of an embodiment of the present invention, disclosed herein is a computer system for rating a plurality of tax deeds of one or more local governments having one or more local government servers coupled with one or more local government tax deed databases containing local government tax deed information available over a public network such as the Internet or over a private network.

In one example, the system includes a computer connected to the network, the computer using a categorization protocol adapted for categorizing the one or more local government tax deed pieces of information from the one or more local government tax deed databases, the computer determining and providing a rating for each of said tax deeds; and a database coupled with the computer and adapted for storing categorized tax deed information and the ratings for each of said one or more tax deeds, the categorized tax deed information and the ratings for each of said tax deeds in the database adapted to be accessible to one or more third-party computers, such as computers used by potential investors, via the network.

In some embodiments, the determined ratings may comprise category values indicating a level of desirableness of an underlying tax lien to a particular class of investor. If the desirability of tax liens/tax deeds is assigned after the categorization process, then standard category values can be assigned for use in computerized purchasing of tax liens/tax deeds. The categorization may be based on a statistical analysis of the investment return associated with various criteria. The categorization may account for not only adjustments to account for risk, but likely average return on investment. For institutional investors, a first hierarchy of category value. On the other hand, personal investors seeking better returns (by paying a smaller premium for the tax lien) may find a second hierarchy of category values unattractive. Personal investors may be willing to take greater risk by paying a smaller premium for a riskier property to obtain the opportunity for a better return. Accordingly, personal investors may prefer a different categorization scheme than institutional investors.

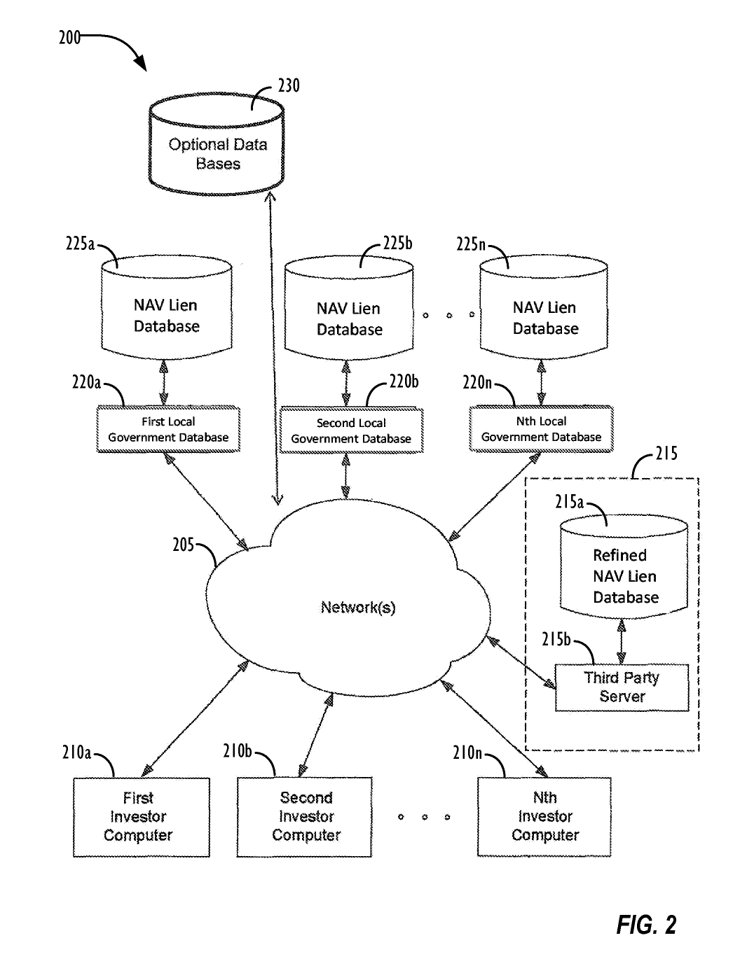

FIG. 2 depicts systems 200 for facilitating automation of categorization and rating of NAV liens. Improvements to NAV lien systems and methods as described herein can maximize associated revenues and save the local government financial resources allocated and associated with making NAV liens available for purchase by investors. According to one embodiment of the present invention, NAV liens are organized into categories and/or subsets that can facilitate comparison among NAV liens and/or meet certain investment parameters.

The components of system 200 are substantially the same as those described above in reference to FIG. 1 and system 100, with the exception of NAV lien databases 225a-225n and Refined NAV lien database 215. In particular, databases 215 and 225 in system 200 contain NAV lien information, rather than the tax lien/tax deed information held by the databases 115 and 125 of system 100 shown in FIG. 1. Otherwise, system 200 also comprises one or more investor computers (210a-210n) that connect through a network 205 (e.g., the Internet, or any other LAN or WAN that facilitates communication between computers) to one or more local government computing systems (220a-220n) that are communicatively coupled with the appropriate underlying NAV lien databases 225a-225n. Investors 210 may also be in contact with a number of other databases as part of system 200, for example: optional data bases 230 and refined NAV lien database system 215 (comprising refined NAV lien database 215a and a third party server 215b).

According to one broad aspect of an embodiment of the present invention, disclosed herein are a computer system and methods for rating a plurality of NAV liens for real properties from one or more local government computing systems across the country. In some embodiments, each local government computing system has at least one local government database containing local government NAV lien information relating to each of the NAV liens in the local government's jurisdiction. In one example, the computer system of this embodiment of the invention comprises at least one computer connected to a network and adapted to communicate with one or more local government computing systems to receive the local government NAV lien information including each of said one or more NAV liens, the computer determining one or more ratings of each of said one or more NAV liens; and at least one database connected with the at least one computer, the at least one database configured to store each of said one or more ratings associated with each of said one or more NAV liens; wherein the one or more ratings of each of said NAV liens is accessible from the at least one database over the network to one or more third party computers, such as computers used by potential investors in evaluating, investing in, or otherwise examining or making decisions based on attributes of and associations with the one or more such NAV liens. In this manner, this embodiment provides ratings of each NAV lien across the one or more local government tax-levying jurisdictions, and these ratings can be used by potential investors to analyze potential purchases of NAV liens from different local governments.

In one example, the one or more ratings of each of said NAV liens are based on one or more common characteristics of the NAV liens, and/or the one or more ratings of each of said NAV liens are based on one or more common characteristics of the real properties associated with the NAV liens. For instance, the one or more ratings of each of said NAV liens may include an indication of whether a NAV lien relates to a residential property, a commercial property, and/or a vacant property. In another example, the one or more ratings of each of said NAV liens may be based upon an assessed value of a property, an amount of a NAV lien, an assessed land value of the real property associated with a NAV lien, and/or an assessed building value of the real property associated with a NAV lien. In this manner, by the computer determining a rating for each NAV lien based on shared, similar, or otherwise related or comparative characteristics of each NAV lien, the computer system can provide the NAV lien ratings to potential investors, so that the investors can use the ratings to quickly compare various NAV liens in one or more local government tax-levying jurisdictions, which thereby helps the investor evaluate which NAV liens the investor may wish to purchase, recommend, or otherwise take an action with respect to said NAV liens.

In another example, the at least one computer of the system obtains other information relating to each NAV lien, e.g., from optional databases 230, including mortgage information related to the real property associated with the NAV lien; bankruptcy information related to an owner of the real property associated with the NAV lien; and/or other items of information, as disclosed herein.

According to another broad aspect of an embodiment of the present invention, disclosed herein is a computer system 210 for rating a plurality of NAV liens of one or more local government having one or more local government servers 220 coupled with one or more local government NAV lien databases 225 containing local government NAV lien information available over a public network 205, such as the Internet or over a private network.

In one example, the system includes a computer connected to the network, the computer using a categorization protocol adapted for categorizing the one or more local government NAV lien pieces of information from the one or more local government NAV lien databases, the computer determining and providing a rating for each of said NAV liens; and a database coupled with the computer and adapted for storing categorized NAV lien information and the ratings for each of said one or more NAV liens, the categorized NAV lien information and the ratings for each of said NAV liens in the database adapted to be accessible to one or more third-party computers, such as computers used by potential investors, via the network. As with the tax liens/tax deeds described above with reference to FIG. 1, the determined ratings of the NAV liens may comprise category values indicating a level of desirableness of an underlying NAV lien to a particular class of investor, such as an institutional investor or personal investor.

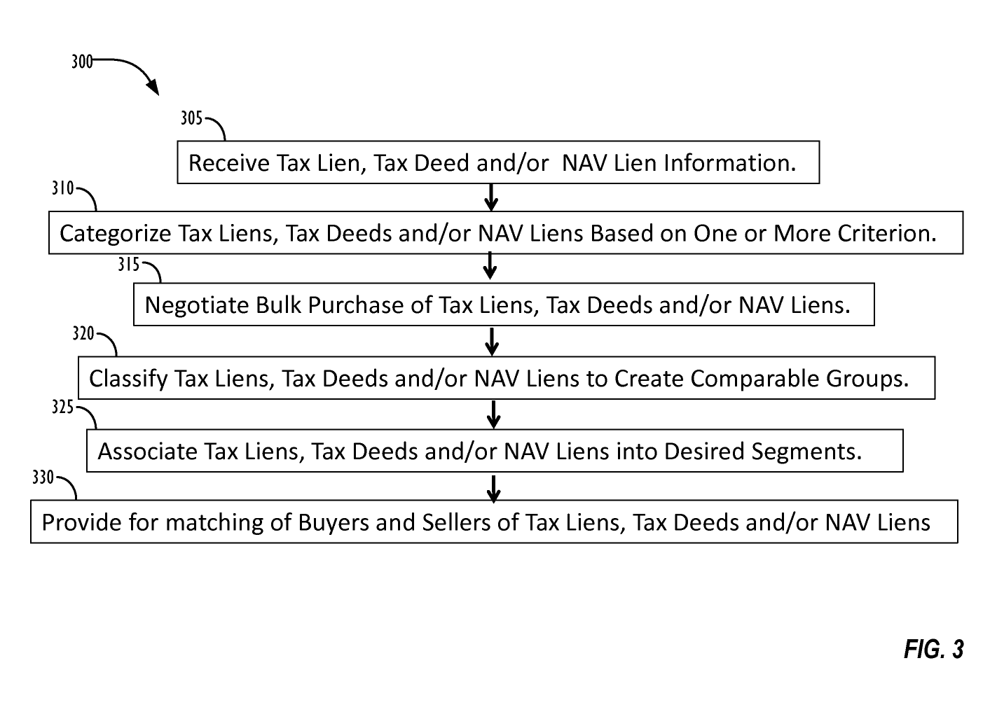

FIG. 3 depicts a method 300 for facilitating: classification of tax liens/tax deeds and/or NAV liens into different categories based on one or more characteristics and/or one or more ratings. First, a computer(s) receives the tax lien, tax deed, and/or NAV lien information (Step 305). Next, the computer(s) categorizes the tax lien, tax deed, and/or NAV lien information based on one or more criterion (Step 310). Next, the computer(s) may negotiate the (bulk) purchase of tax liens/tax deeds and/or NAV liens directly from local governments (Step 315) based on a previously-performed classification and/or rating operation associated with said tax liens/tax deeds and/or NAV liens designed to create comparable groups of tax investment vehicles (Step 320). Next, the computer(s) may associate the tax liens/tax deeds and/or NAV liens into desired segments based on one or more characteristics and/or one or more ratings (Step 325). Finally, the computer(s) may provide for the matching of buyers and sellers of tax liens, tax deeds and/or NAV liens based on one or more characteristics and/or one or more ratings (Step 330). The methods according to the teachings of FIG. 3 may include participation by third-party financing entities in the purchase of tax liens/tax deeds/NAV liens directly from local governments.

Thus, in another example, an embodiment of the system comprises: at least one computer adapted to: receive information comprising tax information relating to two or more tax liens, tax deeds, and/or NAV liens levied on two or more pieces of real property located in at least a first local government jurisdiction and a second local government jurisdiction; determine one or more ratings for the two or more tax liens, tax deeds, and/or NAV liens, wherein the one or more ratings for the two or more tax liens, tax deeds, and/or NAV liens are determined based, at least in part, by the at least one computer using a categorization protocol adapted for categorizing local government tax information, and wherein the determined one or more ratings comprise category values indicating a level of desirableness of the underlying tax liens, tax deeds, and/or NAV liens to a particular class of investor; purchase the two or more tax liens, tax deeds, and/or NAV liens; associate the purchased two or more tax liens, tax deeds, and/or NAV liens into desired segment information based, at least in part, on the determined ratings; make the one or more ratings and desired segment information accessible over a network to one or more third party computers; and match buyers and sellers for the purchased two or more tax liens, tax deeds, and/or NAV liens based, at least in part, on the one or more ratings and desired segment information.

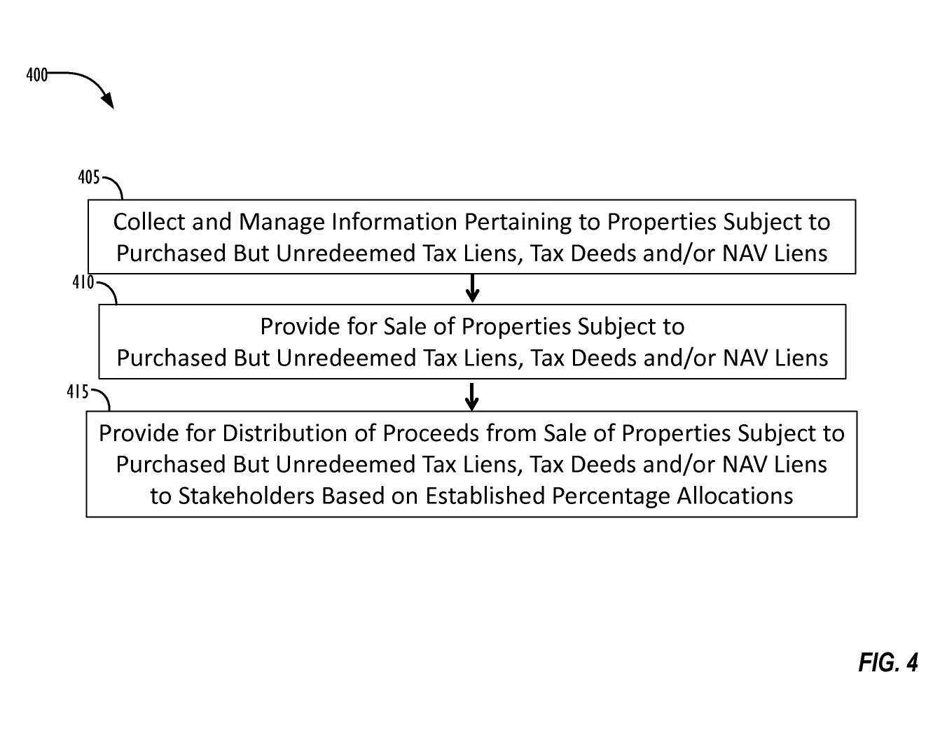

FIG. 4 depicts a method 400 for facilitating: the sale properties subject to purchased but unredeemed tax liens, tax deeds and/or NAV liens; and the distribution of proceeds from the sale of properties subject to purchased (but unredeemed) tax liens, tax deeds and/or NAV liens to stakeholders (which may include but are not limited to local governments) based upon established percentage allocations of proceeds. First the process may collect and manage information pertaining to properties subject to purchased (but unredeemed) tax liens, tax deeds and/or NAV liens (Step 405). Next, the process may provide for the sale of properties subject to purchased (but unredeemed) tax liens, tax deeds and/or NAV liens (Step 410). Finally the process may provide for distribution of proceeds from sale of properties subject to purchased (but unredeemed) tax liens, tax deeds and/or NAV liens to stakeholders based on established percentage allocations (Step 415). The use of proceeds from the sale of properties subject to purchased (but unredeemed) tax liens, tax deeds and/or NAV liens may be used for any purpose including, but not limited to, in the case of stakeholders that are local governments, helping with the financing of public housing and/or education projects and/or other infrastructure services/improvements.

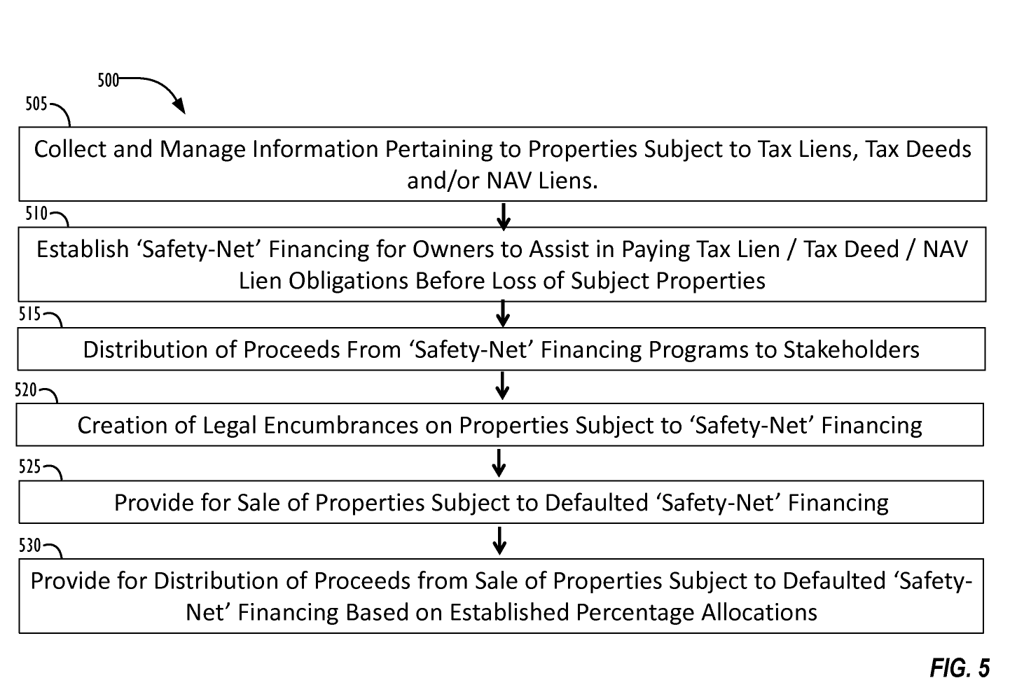

FIG. 5 depicts a method 500 for facilitating: establishment of ‘safety-net’ financing programs to provide assistance to property owners to assist them in paying tax lien/tax deed/NAV lien obligations before loss of subject properties. First, the process may collect and manage information pertaining to properties subject to tax liens, tax deeds and/or NAV liens (Step 505). Next, the process may establish ‘safety-net’ financing for owners to assist in paying tax lien/tax deed/NAV lien obligations before loss of subject properties (Step 510). Next, as is needed, the process may facilitate the following operations: the distribution of proceeds from ‘safety-net’ financing programs to stakeholders (Step 515); the creation of legal encumbrances on properties subject to ‘safety-net’ financing (Step 520); the providing for sale of properties subject to defaulted ‘safety-net’ financing (Step 525); and/or the providing for distribution of proceeds from sale of properties subject to defaulted ‘safety-net’ financing based on established percentage allocations (Step 530).

Distribution of proceeds from ‘safety-net’ financing programs to stakeholders (which may include, but are not limited to, local governments) may be based upon established percentage allocations of proceeds, and the use of proceeds from ‘safety-net’ financing programs may be used for any purpose, including, but not limited to (e.g., in the case of stakeholders that are local governments): help in the financing of public housing and/or education projects and/or other infrastructure services/improvements; creation of legal encumbrances on properties with respect to which property owners receive ‘safety-net’ financing; facilitating the sale of properties subject to ‘safety-net’ financing upon which non-payment defaults occur; and distribution of proceeds from the sale of properties subject to defaulted ‘safety-net’ financing to stakeholders (which may include, but are not limited to, local governments) based upon established percentage allocation of proceeds. The use of proceeds from the sale properties subject to defaulted ‘safety-net’ financing may be used for any purpose including, but not limited to, in the case of stakeholders that are local governments: help in financing public housing and/or education projects and/or other infrastructure services/improvements. The practice of methods according to the teachings of FIG. 5 may also include participation by third-party financing entities in the establishment of ‘safety-net’ financing programs to provide assistance to property owners to assist them in paying tax lien/tax deed/NAV lien obligations before loss of subject properties.

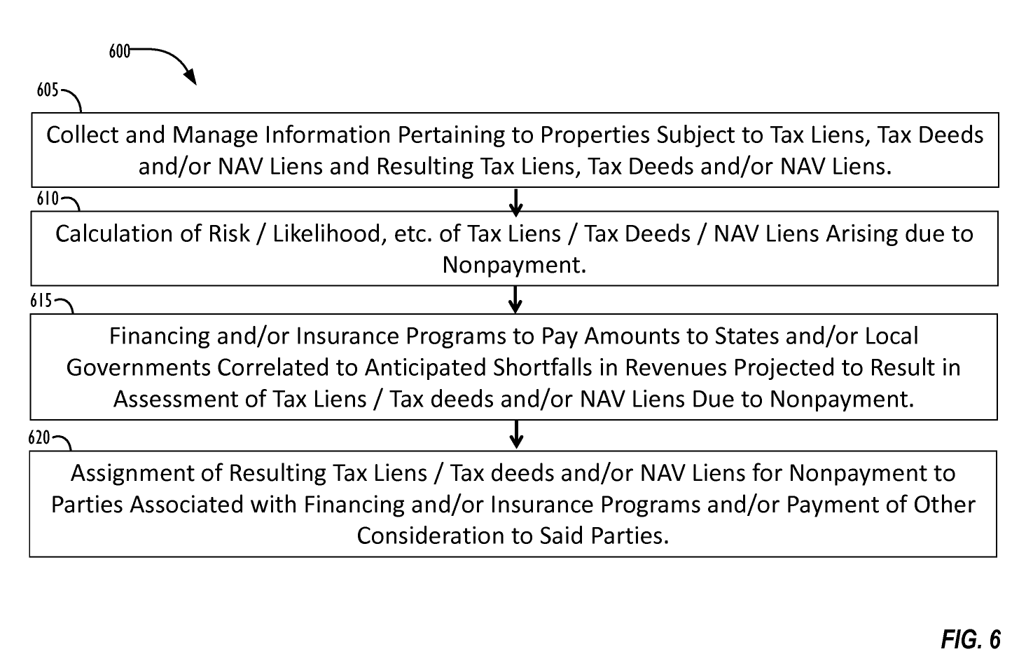

FIG. 6 depicts a method 600 for facilitating: calculation of risk/likelihood, etc. of tax lien/tax deed/NAV liens arising due to non-payment as determined by financial analysis. First the process may collect and manage information pertaining to properties subject to tax liens, tax deeds and/or NAV liens and resulting tax liens, tax deeds and/or NAV liens (Step 605). next, the process may calculate the aforementioned risk/likelihood, etc. of tax liens/tax deeds / NAV liens arising due to nonpayment (Step 610). Next, the process may direct financing and/or insurance programs to pay amounts to local governments correlated to anticipated shortfalls in revenues projected to result in assessment of tax liens/tax deeds and/or NAV liens due to nonpayment (Step 615). Finally, the process may facilitate the assignment of resulting tax liens / tax deeds and/or NAV liens for nonpayment to parties associated with financing and/or insurance programs and/or payment of other consideration to said parties (Step 620).

The risk calculations may include, but are not be limited to, comparison of historical and projected relationships between and among external factors such as economic conditions, rising interest rates, etc., and an assessment of tax liens/tax deeds and/or NAV liens for nonpayment; financing and/or insurance programs that pay local governments amounts correlated to estimated revenues expected to result in assessment of tax liens/tax deeds and/or NAV liens due to nonpayment; and assignment of resulting tax liens/tax deeds and/or NAV liens arising from non payment to parties associated with arranging said financing and/or insurance programs and/or payment of other consideration to said parties.

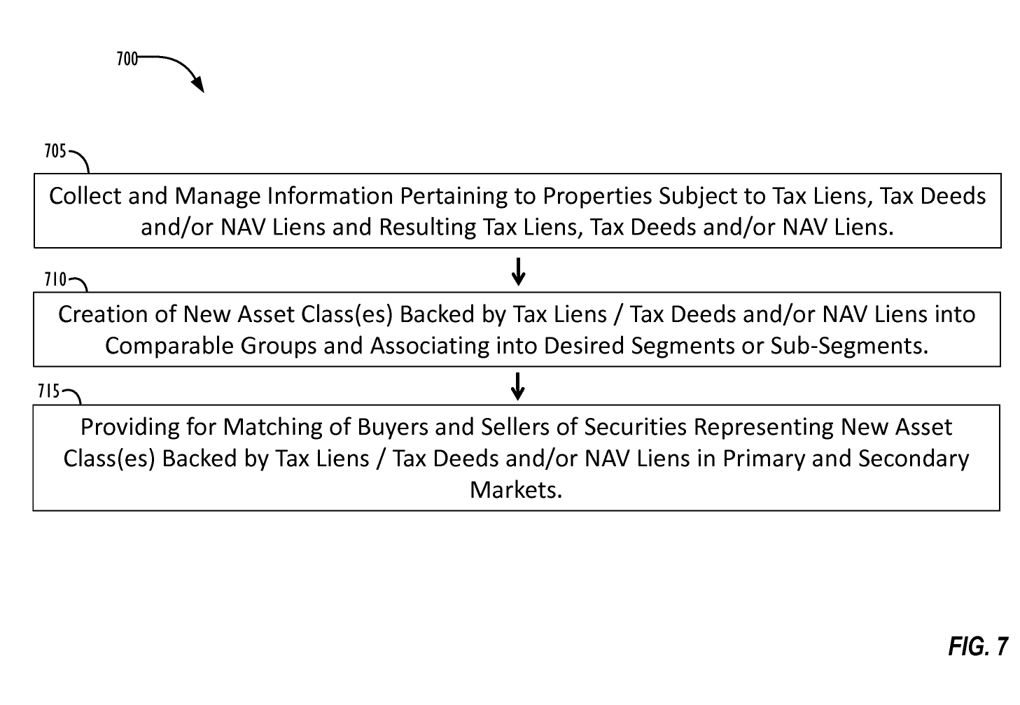

FIG. 7 depicts a method 700 for facilitating: creation of new asset class(es) backed by tax liens/tax deeds and/or NAV liens. First, the process may collect and manage information pertaining to properties subject to tax liens, tax deeds and/or NAV liens and resulting tax liens, tax deeds and/or NAV liens (Step 705). Next, by means of classifying encumbrances, the process may create new asset class(es) backed by tax liens/tax deeds and/or NAV liens that are divided into comparable groups and associate the encumbrances, underlying properties, or other characteristics into desired segments or sub-segments (Step 710). Finally, the process may provide for the matching of buyers and sellers of securities representing the newly-created asset class(es) backed by tax liens/tax deeds and/or NAV liens in primary and secondary markets (Step 715).

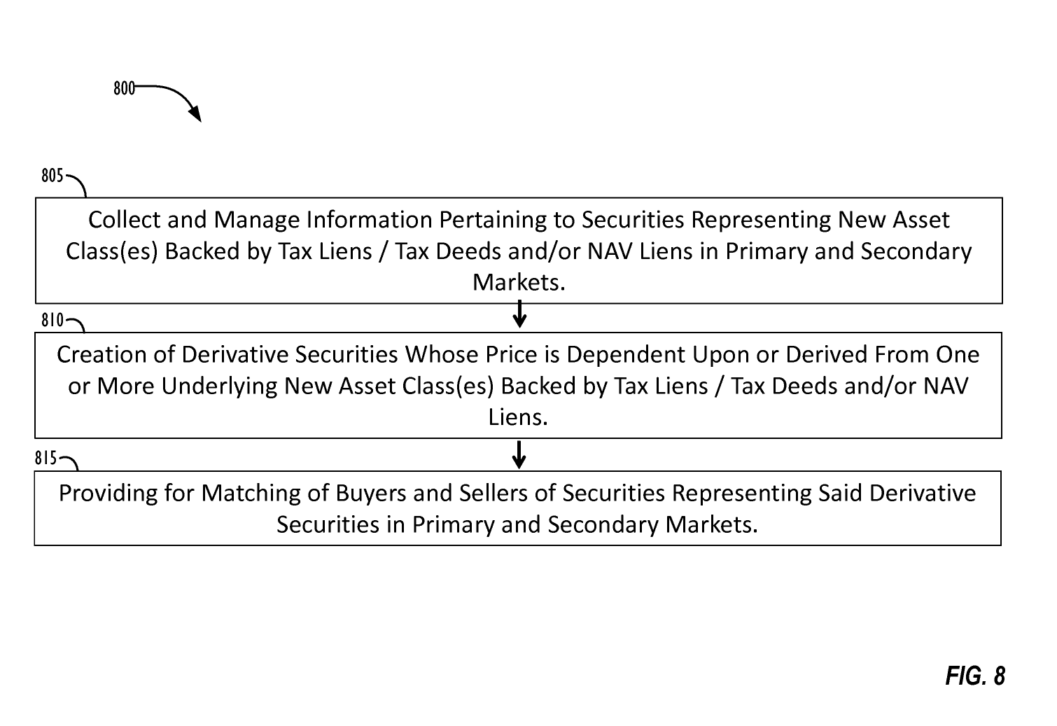

FIG. 8 depicts a method 800 for facilitating: creation of derivative securities (comprised of contracts between or among two or more parties) wherein the securities' price is dependent upon or derived from one or more underlying new asset class(es) backed by tax liens/tax deeds and/or NAV liens. First, the process may collect and manage information pertaining to securities representing new asset class(es) backed by tax liens/tax deeds and/or NAV liens in primary and secondary markets (Step 805). Next, the process may create derivative securities whose price is dependent upon or derived from one or more underlying new asset class(es) backed by tax liens/tax deeds and/or NAV liens (Step 810). According to some embodiments, the securities' value is determined by fluctuations in the value of the underlying asset class(es). Finally, the process may provide for the matching of buyers and sellers of said derivative securities in primary and secondary markets (Step 815).

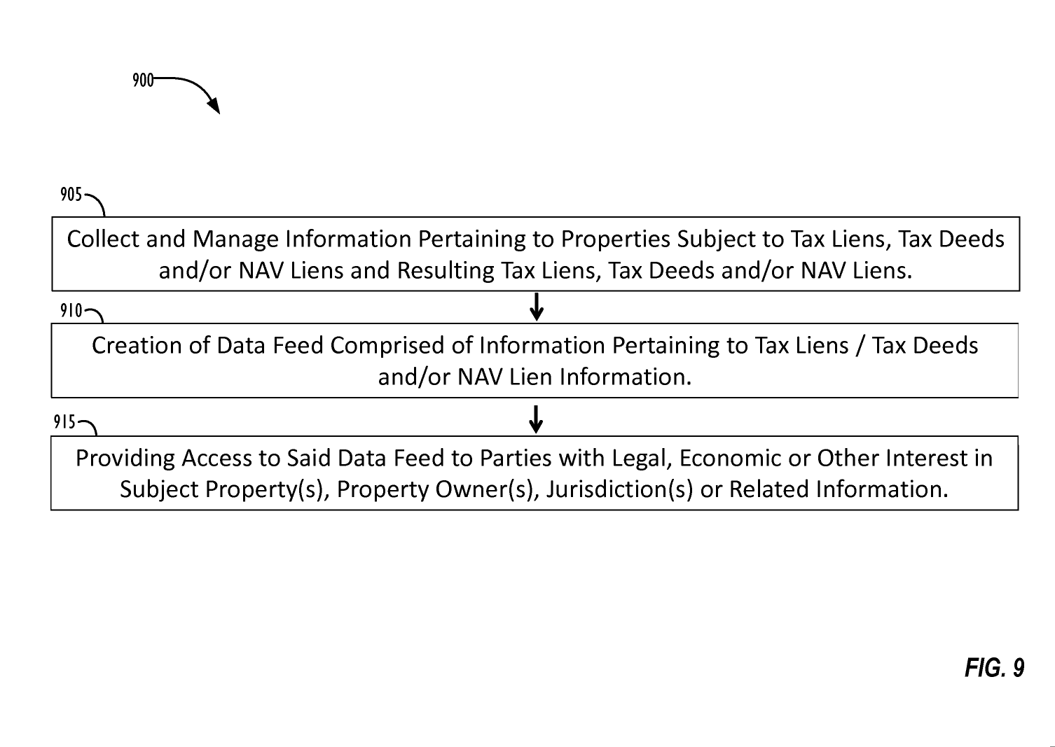

FIG. 9 depicts a method 900 for facilitating: creation of data feeds comprised of information pertaining to tax lien/tax deed and/or NAV lien information that can be used to track, forecast, predict, model and report on assessment and/or repayment of tax liens/tax deeds and/or NAV liens. First, the process may collect and manage information pertaining to properties subject to tax liens/tax deeds and/or NAV liens and resulting tax liens/tax deeds and/or NAV liens (Step 905). Next, the process may facilitate the creation of a data feed comprised of information pertaining to tax lien/tax deed and/or NAV lien information (Step 910). Finally, the process may facilitate the providing of access to said data feed to parties with legal, economic or other interests in subject property(s), property owner(s), local government jurisdiction(s) or related information (Step 915).

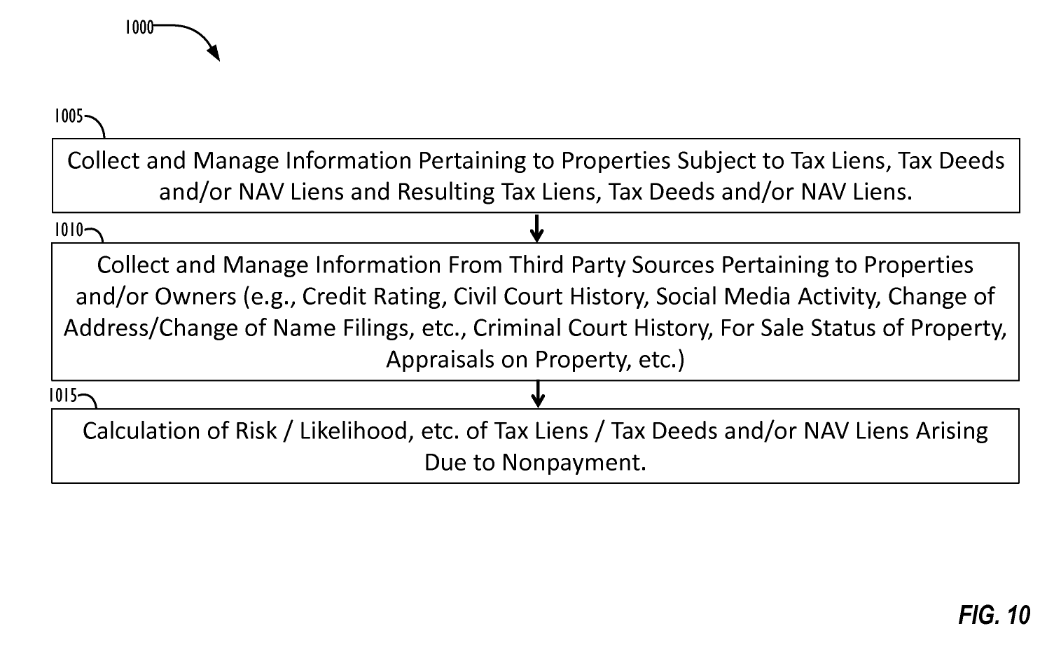

FIG. 10 depicts a method 1000 for facilitating: leveraging third party sources to obtain more information on properties and/or owners to further refine expected categorization/ranking of tax liens/tax deeds and/or NAV liens. First, the process may collect and manage information pertaining to properties subject to tax liens/tax deeds and/or NAV liens and resulting tax liens/tax deeds and/or NAV liens (Step 1005). Next, the process may facilitate the collection and management of information from third party sources pertaining to properties and/or owners (e.g., information such as credit ratings, civil court histories, criminal court histories, whether underlying property is presently or has previously been for sale or otherwise hypothecated, whether there have been recent appraisals on the underlying property, social media activity of owners, change of address/change of name filings, etc.) (Step 1010). Finally, the process may calculate a risk/likelihood, etc. of tax liens/tax deeds and/or NAV liens arising due to nonpayment (Step 1015). The additional third party information may be used in connection with calculation of risk/likelihood, etc. related to likelihood of the investor or investors obtaining value from the tax liens/tax deeds and/or NAV liens arising due to non-payment of the tax liens/tax deeds and/or NAV liens.

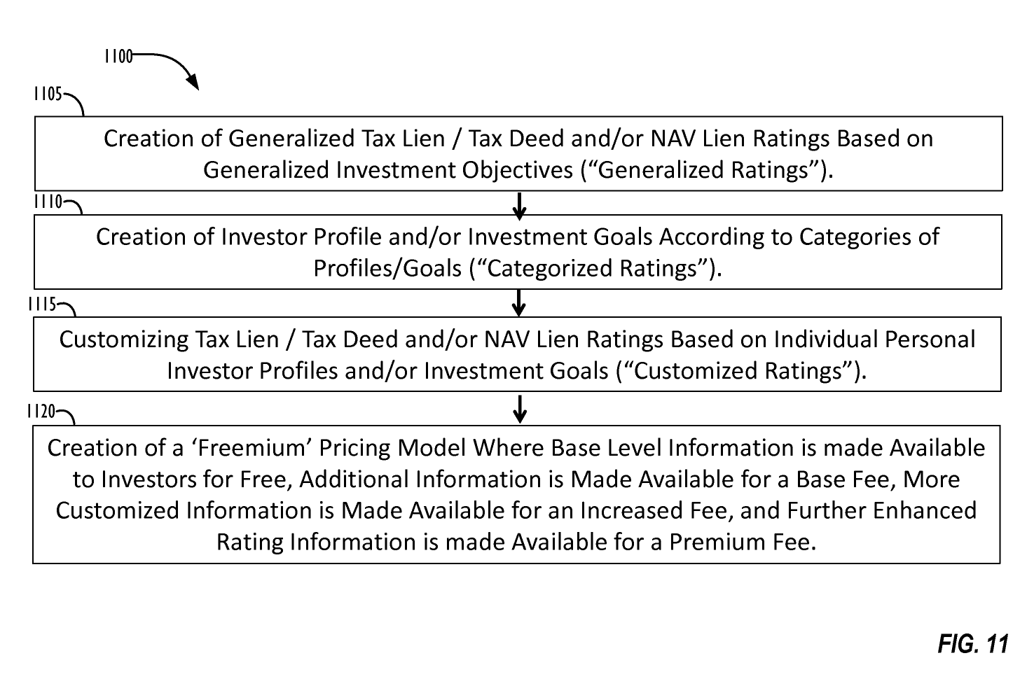

FIG. 11 depicts a method 1100 for facilitating: creation of generalized tax lien/tax deed and/or NAV lien ratings. First, the generalized tax lien/tax deed and/or NAV lien ratings may be created based on generalized investment objectives (“Generalized Ratings”) (Step 1105). Next, the process may facilitate the creation of investor profile and/or investment goals according to categories of profiles/goals (“Categorized Ratings”) (Step 1110). Next, the process may facilitate the customizing of tax lien/tax deed and/or NAV lien ratings based on individual personal investor profiles and/or investment goals (“Customized Ratings”) (Step 1115). Finally, the process may create a ‘freemium’ pricing model, wherein a base level of information is made available to investors for free (e.g., Generalized Ratings), additional information is made available for a base fee (e.g., Categorized Ratings), more customized information is made available for an increased fee (e.g., Customized Ratings), and further enhanced rating information (e.g., ratings enhanced with information concerning the credit rating of the property owner, appraisal values for the property, etc.) is made available to investors who pay a premium fee (Step 1120).

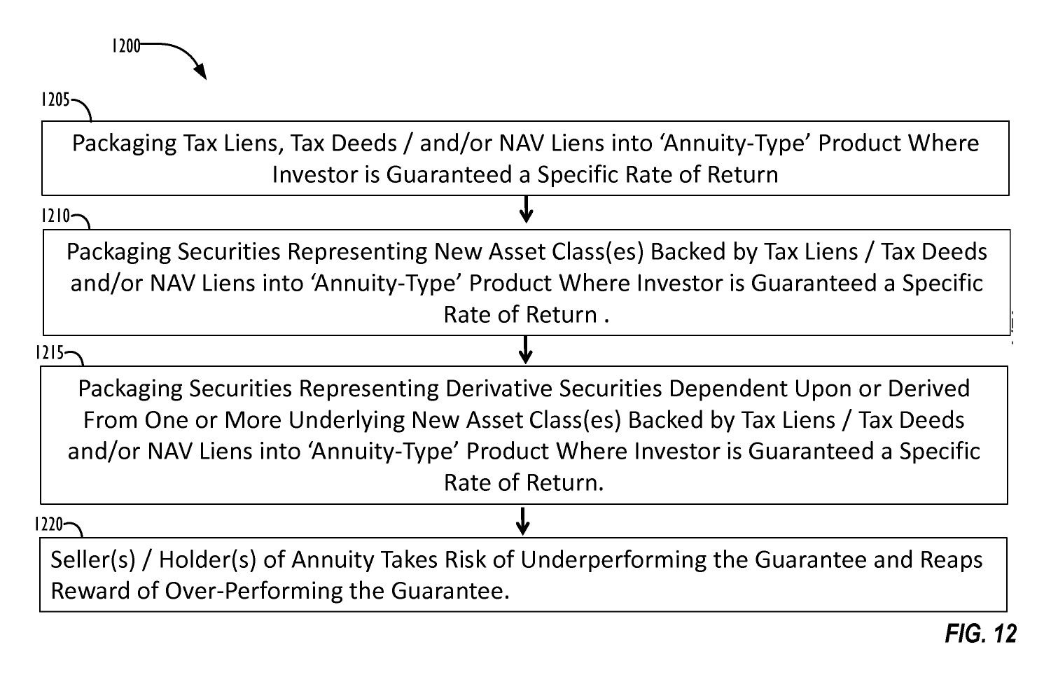

FIG. 12 depicts a method 1200 for facilitating: packaging (i) tax liens/tax deeds and/or NAV liens (Step 1205); (ii) securities representing new asset class(es) backed by tax liens/tax deeds and/or NAV liens (Step 1210); and/or (iii) derivative securities dependent upon or derived from one or more underlying new asset class(es) backed by tax liens/tax deeds and/or NAV liens (Step 1215) into ‘annuity-type’ products, wherein the investor purchasing the ‘annuity-type’ product is guaranteed a specific rate of return. In exchange, the seller/holder of the ‘annuity-type’ product assumes the risk of the ‘annuity-type product’ underperforming the guaranteed rate of return and is therefore positioned to reap the reward if and when the ‘annuity-type product’ over performs the guaranteed rate of return (Step 1220).

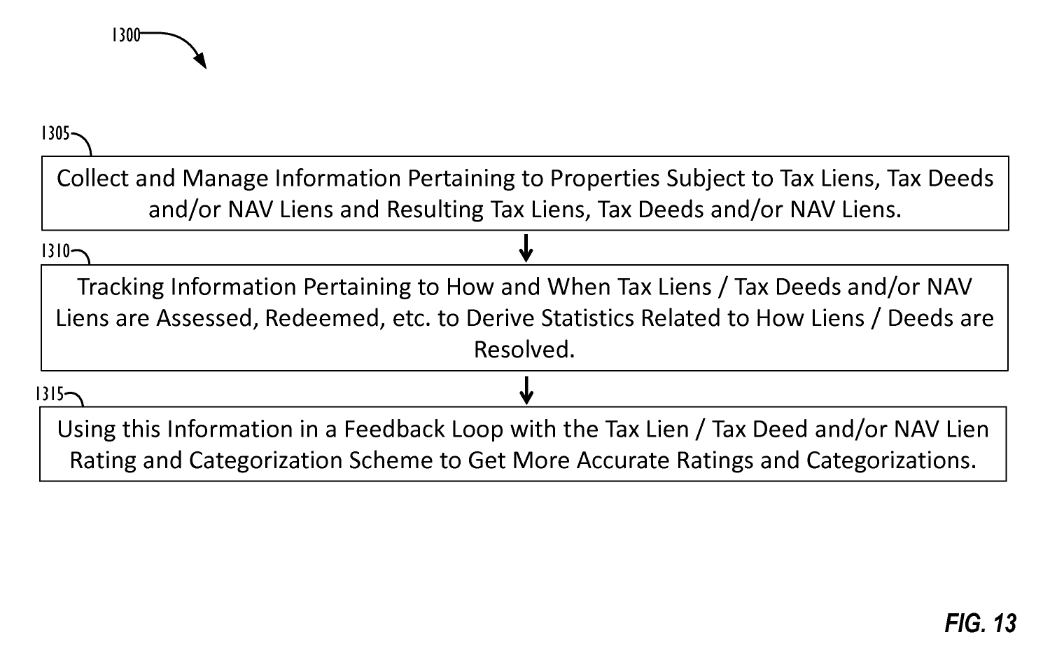

FIG. 13 depicts a method 1300 for facilitating: tracking information pertaining to how and when tax liens/tax deeds and/or NAV liens are assessed, redeemed, etc. First, the process may collect and manage information pertaining to properties subject to tax liens/tax deeds and/or NAV liens and resulting tax liens/tax deeds and/or NAV liens (Step 1305). Next, the process facilitates the tracking of information pertaining to how and when tax liens/tax deeds and/or NAV liens are assessed, redeemed, etc., in order to derive statistics related to how tax liens/tax deeds and/or NAV liens are resolved (e.g., by selling off the property, paying off the debt and when, etc.) (Step 1310). Finally, this information is used in a feedback loop with the tax liens/tax deeds and/or NAV lien rating and categorization scheme to get more accurate ratings and categorizations (Step 1315).

The above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A system, comprising:
at least one computer adapted to:
receive information comprising tax information relating to two or more tax liens, tax deeds, and/or non-ad valorem (NAV) liens levied on two or more pieces of real property located in at least a first local government jurisdiction and a second local government jurisdiction;
determine one or more ratings for the two or more tax liens, tax deeds, and/or NAV liens, wherein the one or more ratings for the two or more tax liens, tax deeds, and/or NAV liens are determined based, at least in part, by the at least one computer using a categorization protocol adapted for categorizing local government tax information, and wherein the determined one or more ratings comprise category values indicating a level of desirableness of the underlying tax liens, tax deeds, and/or NAV liens to a particular class of investor;
purchase the two or more tax liens, tax deeds, and/or NAV liens;
associate the purchased two or more tax liens, tax deeds, and/or NAV liens into desired segment information based, at least in part, on the determined ratings;
make the one or more ratings and desired segment information accessible over a network to one or more third party computers; and
match buyers and sellers for the purchased two or more tax liens, tax deeds, and/or NAV liens based, at least in part, on the one or more ratings and desired segment information.

2. The system of claim 1, wherein the categorization protocol comprises a consideration of at least the following factors: property type, assessed land value, assessed building value, and tax lien, tax deed, and/or NAV lien amount.

3. The system of claim 1, wherein the at least one computer makes the one or more ratings and desired segment information accessible over the network to the one or more third party computers via one or more application programs running on the one or more third party computers.

4. The system of claim 3, wherein at least one of the one or more application programs uses cloud storage.

5. The system of claim 1, wherein the one or more ratings for the two or more tax liens, tax deeds, and/or NAV liens are based on one or more common characteristics of the tax liens, tax deeds, and/or NAV liens.

6. The system of claim 1, wherein the one or more ratings for the two or more tax liens, tax deeds, and/or NAV liens are based on one or more common characteristics of the pieces of real property associated with the tax liens, tax deeds, and/or NAV liens.

7. The system of claim 1, wherein at least one of the one or more ratings comprises:
an indication of whether a tax lien, tax deed, and/or NAV lien relates to a residential property;
an indication of whether a tax lien, tax deed, and/or NAV lien relates to a commercial property; or
an indication of whether a tax lien, tax deed, and/or NAV lien relates to a vacant property.

8. The system of claim 1, wherein at least one of the one or more ratings is based, at least in part, on one or more of:
an assessed value of the piece of real property associated with the tax lien, tax deed, and/or NAV lien that the one or more ratings is for; and
an amount of the tax lien, tax deed, and/or NAV lien that the one or more ratings is for.

9. The system of claim 7, wherein the at least one of the one or more ratings is further based, at least in part, on one or more of:
an assessed value of the piece of real property associated with the tax lien, tax deed, and/or NAV lien that the one or more ratings is for; and
an amount of the tax lien, tax deed, and/or NAV lien that the one or more ratings is for.

10. The system of claim 1, wherein the at least one computer obtains other information relating to at least one of the tax liens, tax deeds, and/or NAV liens, wherein the other information comprises one or more of:
mortgage information associated with the piece of real property associated with the at least one of the tax liens, tax deeds, and/or NAV liens; and
bankruptcy information associated with an owner of the piece of real property associated with the at least one of the tax liens, tax deeds, and/or NAV liens.

11. The system of claim 9, wherein the at least one computer obtains other information relating to at least one of the tax liens, tax deeds, and/or NAV liens, wherein the other information comprises one or more of:
mortgage information associated with the piece of real property associated with the at least one of the tax liens, tax deeds, and/or NAV liens; and
bankruptcy information associated with an owner of the piece of real property associated with the at least one of the tax liens, tax deeds, and/or NAV liens.

12. The system of claim 1, wherein the class of investor comprises at least one of the following classes: institutional investors, and individual investors.

13. A computer-implemented method, comprising:
receiving, by at least one computer, information comprising tax lien information relating to two or more tax liens, tax deeds, and/or non-ad valorem (NAV) liens levied on two or more pieces of real property in at least a first local government jurisdiction and a second local government jurisdiction;
determining, by the at least one computer, one or more ratings for the two or more tax liens, tax deeds, and/or NAV liens,
wherein the one or more ratings for the two or more tax liens, tax deeds, and/or NAV liens are determined based, at least in part, by the at least one computer using a categorization protocol adapted for categorizing local government tax information, and
wherein the determined one or more ratings comprise category values indicating a level of desirableness of the underlying tax liens, tax deeds, and/or NAV liens to a particular class of investor;
purchasing the two or more tax liens, tax deeds, and/or NAV liens;
associating the purchased two or more tax liens, tax deeds, and/or NAV liens into desired segment information based, at least in part, on the determined ratings;
making the one or more ratings and desired segment information accessible over a network to one or more third party computers; and
matching buyers and sellers for the purchased two or more tax liens, tax deeds, and/or NAV liens based, at least in part, on the one or more ratings and desired segment information.

14. The method of claim 13, wherein the categorization protocol comprises a consideration of at least the following factors: property type, assessed land value, assessed building value, and tax lien, tax deed, and/or NAV lien amount.

15. The method of claim 13, wherein the one or more ratings for the two or more tax liens, tax deeds, and/or NAV liens are further determined, at least in part, by the at least one computer using a ranking protocol adapted for ranking tax liens, tax deeds, and/or NAV liens.

16. The method of claim 13, wherein the one or more ratings for the two or more tax liens, tax deeds, and/or NAV liens are based on one or more common characteristics of the tax liens, tax deeds, and/or NAV liens.

17. The method of claim 13, wherein the one or more ratings for the two or more tax liens, tax deeds, and/or NAV liens are based on one or more common characteristics of the pieces of real property associated with the tax liens, tax deeds, and/or NAV liens.

18. The method of claim 13, wherein the class of investor comprises at least one of the following classes: institutional investors, and individual investors.

19. A non-transitory program storage device, readable by a programmable control device and comprising instructions stored thereon to cause the programmable control device to:
receive information from one or more computing systems, the information comprising tax information relating to two or more tax liens, tax deeds, and/or NAV liens on two or more pieces of real property in at least a first local government jurisdiction and a second local government jurisdiction;
determine one or more ratings for the two or more tax liens, tax deeds, and/or NAV liens,
wherein the one or more ratings for the two or more tax liens, tax deeds, and/or NAV liens are determined based, at least in part, by the programmable control device executing instructions stored on the non-transitory program storage device defining a categorization protocol adapted for categorizing local government tax information, and
wherein the determined one or more ratings comprise category values indicating a level of desirableness of the underlying tax liens, tax deeds, and/or NAV liens to a particular class of investor
purchase the two or more tax liens, tax deeds, and/or NAV liens;
associate the purchased two or more tax liens, tax deeds, and/or NAV liens into desired segment information based, at least in part, on the determined ratings;
make the one or more ratings and desired segment information accessible over a network to one or more third party computers; and
match buyers and sellers for the purchased two or more tax liens, tax deeds, and/or NAV liens based, at least in part, on the one or more ratings and desired segment information.

20. The non-transitory program storage device of claim 19, wherein the categorization protocol comprises a consideration of at least the following factors: property type, assessed land value, assessed building value, and tax lien, tax deed, and/or NAV lien amount.

21. The non-transitory program storage device of claim 19, wherein the one or more ratings for the two or more tax liens, tax deeds, and/or NAV liens are further determined, at least in part, by the programmable control device executing instructions stored on the non-transitory program storage device defining a ranking protocol adapted for ranking tax liens, tax deeds, and/or NAV liens.

22. The non-transitory program storage device of claim 19, wherein the one or more ratings for the two or more tax liens, tax deeds, and/or NAV liens are based on one or more common characteristics of the tax liens, tax deeds, and/or NAV liens.

23. The non-transitory program storage device of claim 19, wherein the one or more ratings for the two or more tax liens, tax deeds, and/or NAV liens are based on one or more common characteristics of the pieces of real property associated with the tax liens, tax deeds, and/or NAV liens.

24. The non-transitory program storage device of claim 19, wherein the class of investor comprises at least one of the following classes: institutional investors, and individual investors.
